(19) United States
(12) Patent Application Publication
(10) Pub. No.: US 2024/0253748 A1
(43) Pub. Date: Aug. 1, 2024

(54) METHOD FOR ASSEMBLING A FLOATING SOLAR SYSTEM, AND CORRESPONDING SYSTEM

(71) Applicant: Helioslite, Le Bourget Du Lac (FR)

(72) Inventor: Etienne MENARD, Voglans (FR)

(73) Assignee: Helioslite, Le Bourget Du Lac (FR)

(21) Appl. No.: 18/561,789

(22) PCT Filed: May 19, 2021
(86) PCT No.: PCT/EP2021/063394

§ 371 Date: Nov. 17, 2023

(51) Int. Cl. B63B 35/44; H02S 20/30

(52) U.S. Cl. CPC B63B 35/44; H02S 20/30; B63B 2035/4453

(57) ABSTRACT

This invention mainly proposes a distributed method for fabricating, assembling and launching onto water a floating photovoltaic solar system on a water site, and the corresponding system, said system comprising photovoltaic panels and at least one array of float assemblies, each array of float assemblies comprising at least one float assembly, each float assembly comprising at least one group of at least two floating tube elements for supporting said photovoltaic panels at an inclined angle. The floating tube elements are formed from ribbons or sheets obtained from coils of thin material using a spiral tube forming machine in case of ribbons or a roll-forming machine in case of sheets and mechanically joined together by an array of lightweight frame assemblies.

### FIELD OF THE INVENTION

This invention is in the general field of solar power generation.

More specifically, one particularly important, although nonexclusive, application of the invention is in the field of floating photovoltaic solar systems.

### PRIOR ART DISCUSSION

Most of the floating solar systems which have been deployed relies on the use of plastic floaters which are attached together to form a densely packed “island” which supports an array photovoltaic module at a fixed inclination angle. Patent document EP3083392B1 presents an example of a standard hollow plastic float design which is typically manufactured by blow molding. As these plastic floats have a closed hollow shape, their associated shipping cost is relatively high due to the large volume required for packing and transporting.

Patent document ES1143535U presents an improved float design which comprises a lower part and a cover part which can be packed separately and assembled together on site. As the lower are stackable, for and cover parts the volume required transporting these plastic parts is significantly reduced.

However, as a large amount of raw material is required for the fabrication of these plastic parts the carbon footprint and overall cost for fabricating these floats remains relatively high.

As the molding processes which are used for manufacturing these parts require a minimum wall thickness which is typically 23 mm, the mass of plastic material required for the fabrication of a 1 MW floating solar plant typically exceed 40 tons.

As each float is designed to support only a single PV module and need to be manually assembled and joined together using multiple metallic or plastic fasteners, the time required for assembling this type of floating solar system is relatively high and typically exceeds 500 man-hours for each megawatt (MW) of solar plant power installed.

Moreover, extra floats need to be added inside each island to create service lanes in order to allow maintenance operations to be performed on the floating solar plant.

Patent documents JP2011066200A, US20120279557A1 and U.S. Ser. No. 10/411,643 present alternative float designs relying on elongated tubular shaped flotation elements which are designed to carry a metal frame structure supporting an array of photovoltaic modules.

Here the tubular shaped flotation elements of these floats are typically manufactured using an extrusion process. A minimum wall thickness ≥3 mm is therefore also typically extruded required for the fabrication of hollow shaped profiles (such as tubes).

This second class of float design do not address the material usage issue of standard individual plastic floats as a large mass of raw material is still required for the fabrication of the tubes and module support structure of these floats.

Moreover, the cost for transporting prefabricated tube elements remains high as a large volume is required for packing and shipping these items. In addition, the metal frame structure supporting the array of photovoltaic modules is relatively heavy and complex to assemble as the metal frame structures presented in these prior art systems comprise many elements which are designed to be manually joint together on site using multiple fasteners.

For these two classes of prior art floating solar systems, the overall buoyancy of their flotation elements needs to be over-sized in order to support the weight of an operator walking on a service lane.

In order to limit the cost impact of this requirement, most of the utility scale floating solar system comprise a rather limited number of service lanes.

In such configuration, simple maintenance operations such as replacing or cleaning a photovoltaic module can be quite difficult to perform as a large fraction of the photovoltaic modules installed are not directly accessible from a service lane.

The maintenance operators need to remove several modules and/or walk over their top surface in order to be able to change a photovoltaic module which is not located next to a walk-able service lane.

Finally, for almost all of the prior floating solar systems, an extra row of water ballasted float elements need to be installed around the perimeter of each “island” in order to avoid the risk of lifting when the system is exposed to high winds. This extra border row of float elements adds additional costs and further increase installation time.

As unfortunately it has been widely reported in press articles, this type of design approach is also prone to catastrophic failures as a rupture of a single connection point between the external border row elements and the mooring lines can lead to the total destruction of a large fraction of a floating solar plant.

It is also known (WO 2020/165272) supporting tubes for solar tracker assemblies which limit risks of lifting in strong winds, but which are still to be improved for instance as per their installation cost.

In order to address the main limitations of these prior art solutions, this invention presents a novel float design which relies on a specific distributed manufacturing method which enable significant reductions of the mass of raw material required, a significant reduction of the shipping volume required for transportation and a significant reduction of the time required for assembling and launching onto water this new class of floating solar system.

It is also another object of the invention to provide a float design relying on flotation elements which are designed 5 to be partially filled with water in order to improve the system overall resistance when the floats are exposed to high winds in order to eliminate the risk of a catastrophic failure.

It is yet another object of the invention to provide a specific system layout which comprises underwater mooring lines and unobstructed water service lanes between each row of float elements. These unobstructed water service lanes uniquely enable the use of a dedicated platform for performing maintenance operations in a more efficient and safer manner.

It is a further object of the invention to provide an efficient and easy to run method of maintaining clean and electrically efficient photovoltaic solar systems and their corresponding devices.

According to theses aims one object of the invention is mainly to propose a method for realization of a floating photovoltaic solar system on a water site, said water site having a shore and a water body, said system comprising photovoltaic panels each having a mechanical structure and at least one array of float assemblies, each array of float assemblies comprising at least one float assembly, each float assembly comprising at least one group of at least two floating tube elements for supporting said photovoltaic panels, wherein it comprises the following steps:
obtaining and transporting on the water site coils of thin material,
processing on shore and in situ at least two elongated ribbons or at least two extended sheets obtained from said coils for deforming said ribbons or bending said sheets into at least two corresponding thin wall elongated hollow open tube elements, said open tubes elements extending along a respective primary axis and having respectively unjointed elongated edges arranged to lie against each other, said processing including the step of using a spiral tube forming machine in case of ribbons or a roll-forming machine in case of sheets,
mechanically joining together, the elongated edges of said ribbons or of said sheets using a mechanical crimping, fastening or fixing process, for forming said respective floating tube elements,
fixing an endcap to each end of each of said floating tube elements,
joining together said floating tube elements of each of said group of floating tube elements, with frame assemblies, and mounting said photovoltaic panels onto said frame assemblies or joining together said floating tube elements of each group by fixing the mechanical structure itself of the photovoltaic panels on said floating tube elements, in order to form said at least one array of float assemblies and forming accordingly said floating photovoltaic system, and launching said floating photovoltaic system into water.

By thin material it should be understood a material having a thickness of 2 mm or less than 2 mm, or preferably 1 mm or less than 1 mm.

By mechanically joining together elongated edges using a mechanical crimping, fastening or fixing process it should be understood any joining using fasteners such as bolts, rivets or cold-forming methods relying on clinching tools or welding processes or structural glue or alternative fastening methods known in the art.

Advantageously the coils are raw metal coils, for example in aluminum, but it can also be thin flexible composite material or even thin flexible sheet or ribbon of plastic material.

In an advantageous embodiment the processing is more specifically using a spiral tube forming machine to deform said ribbons in spiral having their unjointed longitudinal adjacent elongated edges mechanically crimped together to fabricate said respective floating tube element.

In another advantageous embodiment the processing is using a roll forming machine to bend said sheets in order to have their unjointed elongated edges relying against each other and then having them mechanically joined together using such mechanical crimping, fastening or fixing process for forming said respective floating tube elements.

In another embodiment of the invention it is proposed a method for realization of a floating photovoltaic solar system on a water site, said water site having a shore and a water body, comprising photovoltaic panels each having a said system structure and least one mechanical at array of float assemblies, each array of float assemblies comprising at least one float assembly, each float assembly comprising at least one group of two at least floating tube elements for supporting said photovoltaic panels, wherein it comprises the following steps:
obtaining and transporting on the water site coils of thin material,
processing on shore and in situ elongated ribbons obtained from said coils for deforming them into at least two thin wall elongated hollow open tube elements, said open tube elements extending along a respective primary axis, said processing including the step of using a spiral tube forming machine for forming said open tube elements,
mechanically joining together the long edges of said metal ribbon to fabricate said respective floating tube elements,
fixing an endcap to each end of each of said floating tube elements,
joining together said floating tube elements of each of said group of floating tube elements, with frame assemblies, and mounting said photovoltaic panels onto said frame assemblies or joining together said floating tube elements of each group by fixing the mechanical structure itself of the photovoltaic panels on said floating tube elements, in order to form said at least array of float assemblies and forming accordingly said floating photovoltaic system.

Additionally, it further comprises a step of launching said floating photovoltaic system into the water body, either one by one float assembly or successively each array of float assemblies already connected between each other.

In an alternative embodiment, it is also and/or further proposed a method for realization of a floating photovoltaic solar system on a water site said water site having a shore and a water body, said system comprising photovoltaic panels each having a mechanical structure and at least one array of float assemblies, each array of float assemblies comprising at least one float assembly, each float assembly comprising at least one group of at least two floating tube elements for supporting said photovoltaic panels, wherein it comprises the following steps:
obtaining and transporting on the water site coils of thin material,
processing on shore and in situ sheets obtained from said coils for bending them into at least two thin wall elongated hollow open tube elements having respectively unjointed elongated edges lying against each other, said open tube elements extending along a respective primary axis, said processing including the step of using a roll-forming machine,
mechanically joining together, the edges of each respective open tube elements welding, mechanical crimping, fastening or fixing process, for forming said respective floating tube elements,
fixing an endcap to each end of each of said floating tube elements,

joining together said floating tube elements of each of said group of floating tube elements, with frame assemblies, and mounting said photovoltaic panels onto said frame assemblies or joining together said floating tube elements of each group by fixing the structure itself of the photovoltaic panels on said floating tube elements, in order to form said at least array of float assemblies and forming accordingly said floating photovoltaic system, with or without further launching of said floating photovoltaic system into the water body.

In some advantageous embodiments, it is also and/or further proposed a method for realization of a floating photovoltaic solar system on a water site, according to any of the methods described hereabove, also and/or alternatively including one or more of the following features:
the coils are raw metal coils;
the method further includes the step of inserting buoyancy elements inside said floating tubes elements, before fixing the end-caps.

This authorizes manufacturing floating tube elements which are not waterproof, while keeping the floating feature. Accordingly the steps of joining together the edges of each respective open tube elements and of fixing the end-caps have not to be perfectly and hermetically executed and can authorize leaks;
the end-caps having a centered or substantially centered aperture authorizing overflow, the method comprises, after launching, the step of having water leaking into the bottom of the floating tube elements up to the overflow aperture while the floating tube elements are immerged so as to augment the stability of the system. It is because the water playing a role of ballast, greatly improves the resistance against reversing in case of strong winds;
the launching of the system comprises a step of placing two guiding elongated rails elements with one extremity on shore and the other extremity sufficiently immerged into the water body, a step of mechanically connecting together in series and in line at least two float assemblies to form a corresponding array of float assemblies, said array therefore forming a train of connected float assemblies while placing such array on said two parallel guiding elongated rails elements such as to form a launch ramp in order to support and guide said train of solar floats assemblies into the water body, the floating tube elements being arranged to slide along the rails and a step of driving such train entirely into the water body by pushing and/or pulling such train accordingly;
providing said launch ramp with a total length superior to ten meters in order to support a plurality of at least two arrays of float assemblies, each array comprising, for example, at least two and advantageously five photovoltaic solar panels;
the placing of the guiding elongated rails elements comprises providing an array of vertical posts having adjustable lengths foots driven into the ground using a post ramming machine or mounted onto other foundation elements such as concrete blocks or ground screws, to support such rails elements;
the method further comprises a step of dispatching a plurality of arrays of float assemblies on a predetermined surface of the water body, a step of providing a linear array of a plurality of horizontal cables positioned at a depth of at least 0.5 m under the water body surface, a step of using short vertical cables or chains for mechanically connecting said arrays of float assemblies to the horizontal cables, and a step of providing anchoring lines connecting said horizontal cables to an array of anchoring points installed on shore and/or at the bottom of the water body;
the method further comprises the step of arranging around at least one array of float assemblies or a group of arrays of float assemblies, one pair of corresponding external (or peripheral) lateral horizontal cables and one pair of corresponding external longitudinal horizontal cables perpendicular to said pair of lateral horizontal cables and belonging to said array of a plurality of horizontal cables and securing such array or group of arrays with anchoring cables attached to a plurality of fixed foundation points;
the solar float system being organized in parallel rows of at least two arrays of float assemblies, therefore creating external or intermediate parallel free water surface or canal having a width equal or superior to a predetermined value, the method of installation further comprises a maintenance method comprising the step of performing maintenance operations on said floating solar system by using a maintenance platform comprising a pair of buoyancy elements which are joined together by a frame structure in order to create a stable catamaran type platform floating on said two parallel canals along and/or between two adjacent rows of arrays of float assemblies and navigating above and between said rows of float assemblies to maintain and/or replace defective solar panels or modules.

By creating paths between the rows of float assemblies, which authorizes the catamaran platform to circulate above each specific row, maintenance is greatly ameliorated.

The present invention further proposes a floating photovoltaic solar system on a water site, to be used with the above-mentioned methods.

It also proposes a floating photovoltaic solar system on a water site having a shore and a water body, said system comprising photovoltaic panels and at least one array of float assemblies, each array of float assemblies comprising at least one float assembly,

wherein each float assembly comprises at least one group of at least two floating tube elements for supporting said photovoltaic panels,

each of said floating tube elements having a thin (i.e. <1 mm) elongated wall extending along a primary axis, said floating tube elements being formed by bending metal ribbons or sheets extracted from raw metal coils using a spiral tube forming machine or a roll-forming machine, to obtain an open cylinder with adjacent longitudinal edges facing each other, and having means of fixation by mechanical crimping, fastening, gluing or welding of such adjacent longitudinal edges of such open cylinder to close longitudinally such floating tube elements,

each end of said floating tube elements being closed by an endcap,

wherein it comprises frame assemblies to support said photovoltaic panels in order to form said at least one array of float assemblies for forming said floating photovoltaic system,

and a launching apparatus of said at least one array of float assembly forming said floating photovoltaic system into the water body.

In some advantageous embodiments, it is also and/or further proposed a floating photovoltaic solar system on a water site including one or more of the following features:
each float assembly comprises at least one group of three parallel floating tube elements for supporting said photovoltaic panels;
the floating tube element not being waterproof, the end-caps have a centered or substantially centered aperture authorizing overflow of water when said floating tube element is immerged;
each floating tube element comprises at least one buoyancy element inside;
the system comprises multiple mooring lines operably connected to said array of float assemblies;
the system comprises anchoring lines connecting said mooring lines to an array of anchoring points;
each floating tube element has a length superior to 5 m;
each float assembly comprises a minimum of three frame elements extending along a direction which is perpendicular to said primary axis of said floating tube elements, said frame elements are operably connected to said floating tube elements;
the system comprises a plurality of arrays of float assemblies, forming a train of connected float assemblies and the launching device comprises two parallel guiding elongated rails elements arranged to support and guide said train of solar floats assemblies into the water body;
the system comprises an array of vertical posts having adjustable lengths driven into the ground or mounted on to foundation elements such as concrete blocks or ground screws, to support such rails elements;
the system comprises a plurality of horizontal cables and a short vertical cables or chains mechanically connected to said arrays of float assemblies and anchoring lines connecting said horizontal cables to an array of anchoring points installed on shore and/or at the bottom of the water body;
the system further comprises for at least one array of float assemblies or a group of arrays of float assemblies, one pair of corresponding external (or peripheral) lateral horizontal cables and one pair of corresponding external longitudinal horizontal cables perpendicular to said pair of lateral horizontal cables and belonging to said array of a plurality of horizontal cables and securing such array or group of arrays with anchoring cables attached to a plurality of fixed foundation points;
one embodiment of the invention concerns a floating photovoltaic solar system comprising a maintenance platform comprising a pair of buoyancy elements which are joined together by a frame structure to form a catamaran type platform;
one embodiment of the invention concerns a floating photovoltaic solar system comprising a water drip system, said water drip system comprising at least one perforated water pipe attached along the upper side of the solar panels using an array of fixation clips and an external water pump for pumping fresh water from a reservoir and/or the water body onto the upper surface of said solar panels;
the water drip system comprises multiple perforated water pipes connected in a series manner by connecting the output inlet of a first perforated water pipe to the input inlet of the following float assembly.

Advantageously, another object of the invention is to propose a maintenance process and apparatus according to the above-mentioned related and relevant part of the description and/or to provide a float layout installation configuration which uniquely enable the use of a specific floating platform to perform maintenance operations on an installed system in a safer manner and/or to the above-mentioned according description.

Another object of the invention is to provide a water drip process and/or system for cleaning solar photovoltaic panels of a floating photovoltaic solar system as described above and/or eliminating the risk of accumulation of snow on the upper surface of the photovoltaic panels or modules of such a system and/or cleaning their upper surface in a continuous and automated manner, as described above and further described hereafter.

### BRIEF DESCRIPTION OF THE DRAWINGS

The above and other features and advantages of the present invention will become apparent upon review of the following summarized and detailed descriptions taken into conjunction and in a no limitating way with the accompanying drawings in which:

FIG. 1 shows a schematic general diagram in perspective illustrating the different steps of one embodiment of the method and/or system of realization of a floating photovoltaic solar system according to the invention, using a spiral tube forming machine.

FIG. 2 shows a view in perspective of another embodiment of the processing step of the invention to form the floating tube elements using a roll forming machine.

FIGS. 3A, 3B & 3C show perspective views at an angle of a float assembly which is arranged for supporting an array of five solar panels or modules, according to a first embodiment (FIGS. 3A and 3B) with frame assemblies for supporting such panels, respectively equipped with said panels (FIG. 3A) and without such panels (FIG. 3B), and according to a second embodiment (FIG. 3C) wherein the frame assembly is reduced as the junction between the floating tube elements is obtained by the mechanical structures or frames of the photovoltaic panels themselves.

FIG. 4 shows a perspective view at an angle of a float assembly according to another embodiment of the invention, with three parallel floating tube elements arranged for supporting an array formed of two sets of five panels having their respective top part substantially adjacent to each other and being inclined in opposite directions.

FIG. 5 shows cross section view of another embodiment of a float assembly of the invention with tree floating tube elements arranged for supporting an array of solar panels orientated in the same direction.

FIGS. 6A, 6B and 6C show cross section views of three embodiments of elongated floating tube elements (also called float elements), used with the invention arranged to be partially filled with water. FIG. 6D shows a front view of an end-cap according to an embodiment of the invention.

FIG. 7 is a flow diagram showing the first steps of the method for realization (fabricating and assembling) of the floating photovoltaic solar system according to the embodiment of the invention more particularly described herewith.

FIG. 8 shows a 3D view diagram of a launching device equipped with an array (a train) of float assemblies according to one embodiment of the invention, comprising a ramp for assembling and launching into water several float assemblies in a row.

FIG. 9 is a side view of an embodiment of the floating photovoltaic solar system showing a solution for anchoring an array of four float assemblies according to one embodiment of the invention, in the water body.

FIG. 10 shows a top view diagram of an example of layout showing interconnecting and anchoring of a plurality of arrays of float assemblies according to an embodiment of the invention in a water body.

FIGS. 11A and 11B show two perspective views respectively of a platform and of a system comprising a platform for performing maintenance operations on a floating photovoltaic solar system according to an embodiment of the invention.

FIG. 12 shows a perspective view at an angle of a float assembly equipped with a water drip system according to an embodiment of the invention.

### DETAILED DESCRIPTION OF THE INVENTION

The invention essentially provides a distributed method for fabricating and assembling a novel class of floating photovoltaic system which minimizes material usage, reduces shipping volume, simplifies field assembly, provide an optimized system layout with unobstructed water accessible service lanes for performing maintenance operations using a dedicated maintenance platform in order to improve the competitiveness of floating solar plants.

In the following the same numbers of reference will be preferably used for designating the same or similar elements.

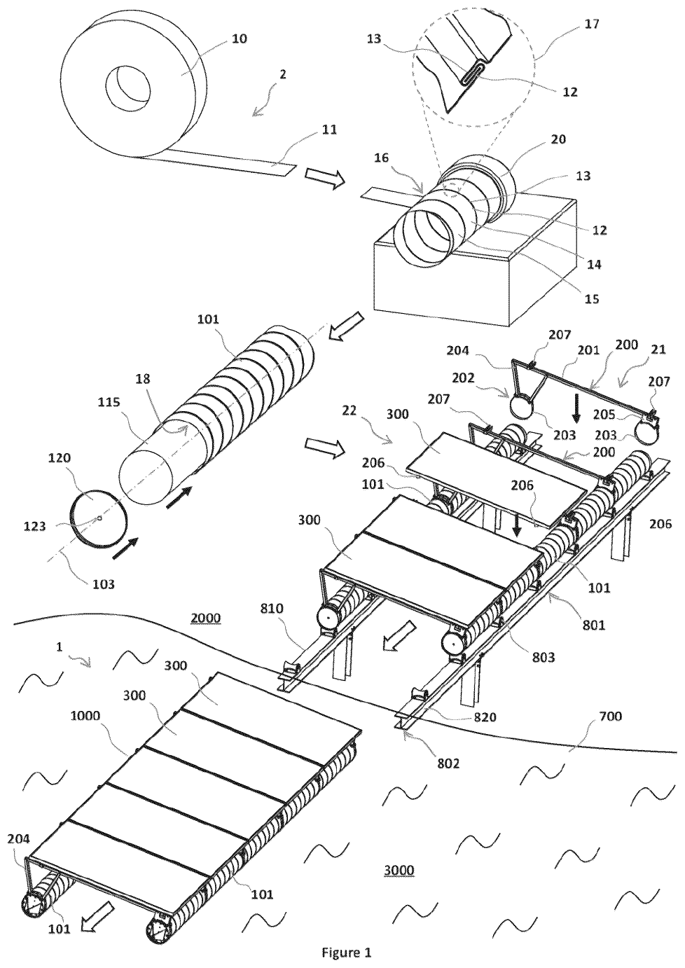

FIG. 1 shows the principal steps of realization of a floating photovoltaic solar system 1 comprising the first step (referenced 2) of obtaining and transporting at least one coil 10 of thin material, for instance a coil of a film of raw aluminum of ˜2000 kg having a length of 5300 m, a width of 140 mm and a thickness of 1 mm.

The coil 10 is developed in a ribbon 11 with tools known per se and wounded progressively on itself with a determined offset in order to create the floating tube element 101 (step 3) while fixing by crimping the elongated edges 12, 13 in vis à vis of two successive rounds 14 and 15 of the spiral 16 progressively formed by the spiral tube forming machine 20 known in itself.

On FIG. 1, (see enlarged view referenced 17) the respective elongated edges 12 and 13 are mechanically joined together, using a mechanical crimping process by blocking their respective periphery inside a fold of the edge of the other as shown on FIG. 1 with a crimping device known per se.

As the spiral tube may not be perfectly waterproof, as in this embodiment, and in order to obtain the requested buoyancy, a for instance airbags, are plurality of containers 115, introduced in the hollow part 18 of the tube, and are for example arranged to fill approximately two third of the interior volume of the tube for instance two airbags of 130 liters for a tube of 5 m of length and 30 cm of diameter.

Once the floating tube element 101 is completed endcaps 120 are fixed by crimping or any other known fixing means at both ends of the tube element, said endcaps having for example a central hole 123 to authorize ballasting with water.

The next step of the process (see reference 21) is the junction of two floating tube elements 101, i.e., a first tube element and a second tube element, parallelly disposed at a predetermined distance, with frame assemblies 200.

Each frame assembly is for instance in aluminum (in the same metal than the tube elements), each of said frame assemblies being formed by a transversal elongated member 201 attached at its ends to two respective fixating collars 202.

Each collar comprises for instance one open circle 203 to be bound to the tube and one structural beam member rigidly fixed to said open circle, at one end corresponding to the first tube via a beam member 204 of a first height of a predetermined value and at the other end corresponding to the second tube to a second beam member 205 of a second high of a smaller predetermined value, each fixed to a circle 203 on one end and to the transversal elongated member 201 on the other end, therefore implying a slope of several degrees, for instance 10° for the photovoltaic panel 300 which will be rigidly fixed on two parallel frame assemblies disposed at a distance to each other corresponding or slightly less than the width of the panels 300.

The next step (step reference 22) is the mounting of the photovoltaic panels on said frame assemblies one aside each other to form a float assembly 1000 of five panels 300, the panels being fixed on said frame assemblies for example with fastening clip 206 such as clips commercialized under the trade mark PowAR Snap of the French firm ARaymond.

According to a preferred embodiment of the invention the float assembly is launched via two guiding elongated rails elements 810 & 820 parallelly disposed with one section 801 on shore 2000 and one extremity 802 immerged into the water body 3000. Guiding rollers 840 allows a smooth s displacement of the floating tube elements 101 on the rails in a way known per se. At the end the float assembly 1000 is floating on the water body 3000 and ready to be navigated to its anchoring place.

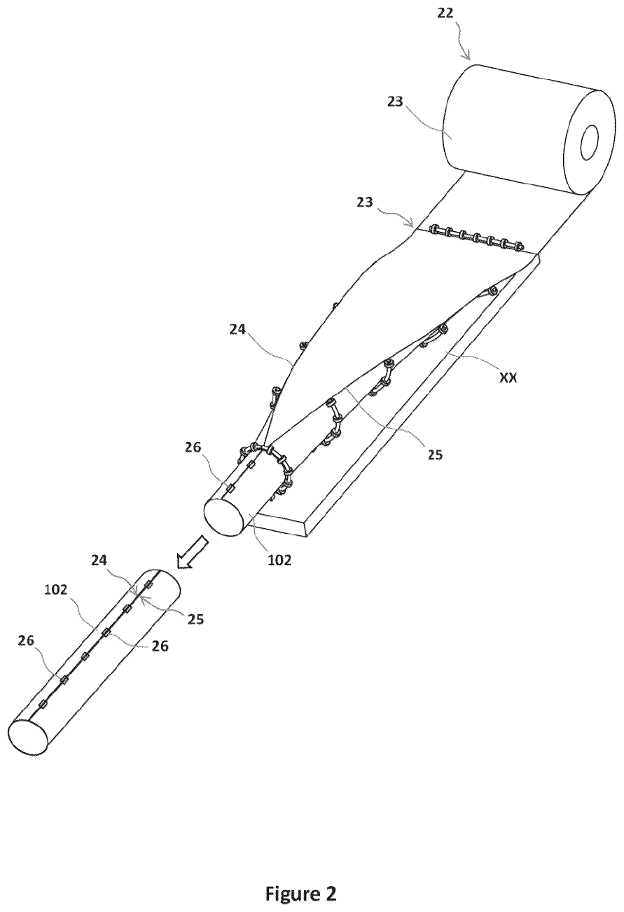

FIG. 2 shows another embodiment of forming of a tube element 102 using a roll forming machine 22 from a coil 23 of larger width for instance 95 cm, the length of the tube element being determined by cutting the coil at the right distance.

The edges 24 and 25 of the open tube are joined together for example with rivets or clips 26 and/or glued or welded or mechanically crimped together in order to obtain the finished floating tub element 102.

The following steps of forming the system are for instance corresponding to the ones precedingly described hereabove.

FIGS. 1 3A and 3B show 3D view diagrams of a float assembly 1000 according to one embodiment of the invention which is arranged for supporting an array of five photovoltaic panels or modules 300.

This embodiment of solar float assembly 1000 comprises two identical hollow tubes elements 101 which are operably connected together with six successive frame assemblies 200 regularly disposed at a distance and arranged to support a panel two by two.

In this preferred embodiment of the invention, an array of five photovoltaic solar modules 300 are operably connected to the frame assemblies 200, using multiple module support brackets 207, which are designed to support the solar modules 300 at an inclined angle. In the Northern hemisphere, the solar modules are preferably inclined toward South and in the Southern hemisphere toward North. In both cases, the float assembly 1000 and hollow tube elements 101 have their principal axis 103 oriented along a North-South direction.

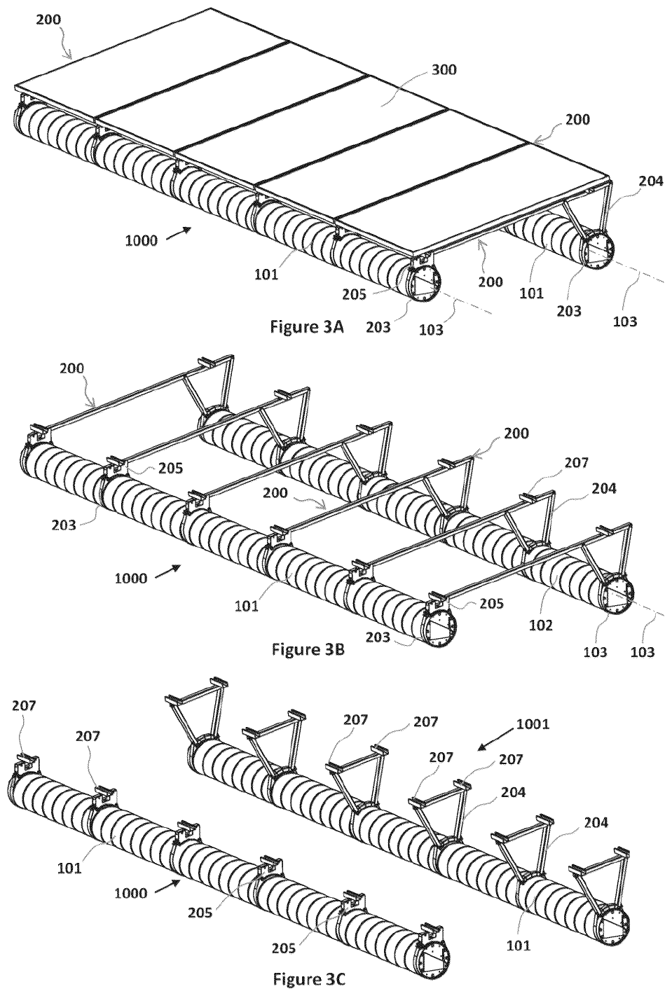

FIG. 3C shows a 3D view diagram of a float assembly 1001 according to another embodiment of the invention relying on frame assemblies which are segmented in two sub-frames.

A first set of sub-frame assemblies 205 are operably connected to the first tube element 101 and a second set of sub-frame assemblies 204 are operably connected to the second tube element 101. In this embodiment of the invention, the two sub-frame assemblies are simply operably connected together through the metal frames or mechanical structures of the solar modules or photovoltaic panel 300.

In this embodiment of the invention, the second sub-frame assemblies 204 are preferably equipped with a pair of two module support brackets 207 in order to improve the overall mechanical resistance of the float assembly 1000 when it is equipped with an array of solar modules.

In a preferred embodiment of the invention, the inclination angle of the solar modules is lower than 20° in order to minimize wind drag coefficients.

In alternative embodiments of the invention, the float assemblies may be equipped with a different number (N) of solar modules 300. In these alternative embodiments, N+1 frame assemblies 200 are used for supporting N photovoltaic modules 300.

In a preferred embodiment of the invention the hollow floating tube elements 101 have a cylindrical shape.

In other embodiments of the invention the hollow tubes may have a different cross section shape such as a square, rectangle, hexagonal, or any closed shape polygon profile.

The hollow tube elements 101 are operably connected to the frame assemblies 200 using thin sheet fastening solutions. The module support brackets 207 are operably connected to each frame assembly 200 using thin sheet fastening solutions.

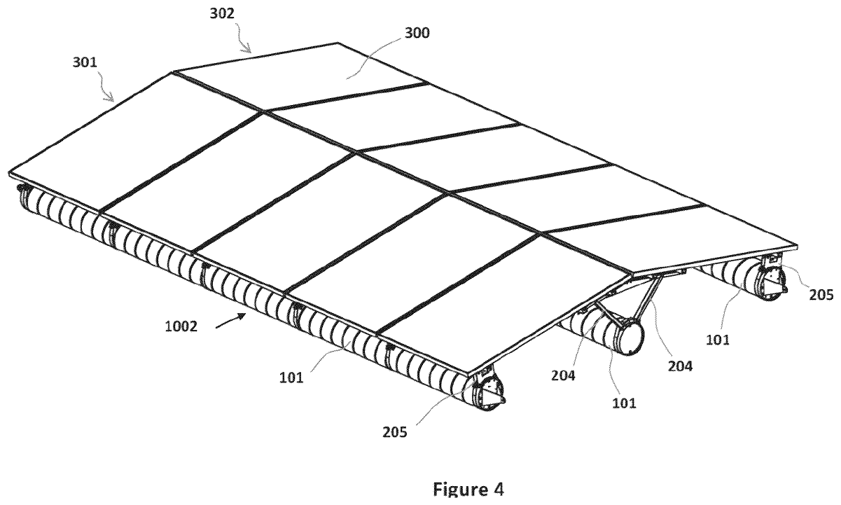

In another embodiment of the invention, the frame assemblies may be configured to support two rows 301 and 302 of photovoltaic modules 300 inclined at an angle toward East and West as illustrated in FIG. 4. In this embodiment of the invention, a first set of sub-frame assemblies 205 are operably connected to a pair of side tube elements 101 and a second set of center sub-frame assemblies 204 are operably connected to a central third tube element 101. In this embodiment of the invention, the sub-frame assemblies are simply operably connected together through the metal frames of the solar modules 300. In the case of this design configuration, the floating tube elements 101 of the float assembly 1000 are preferably oriented along a North-South axis.

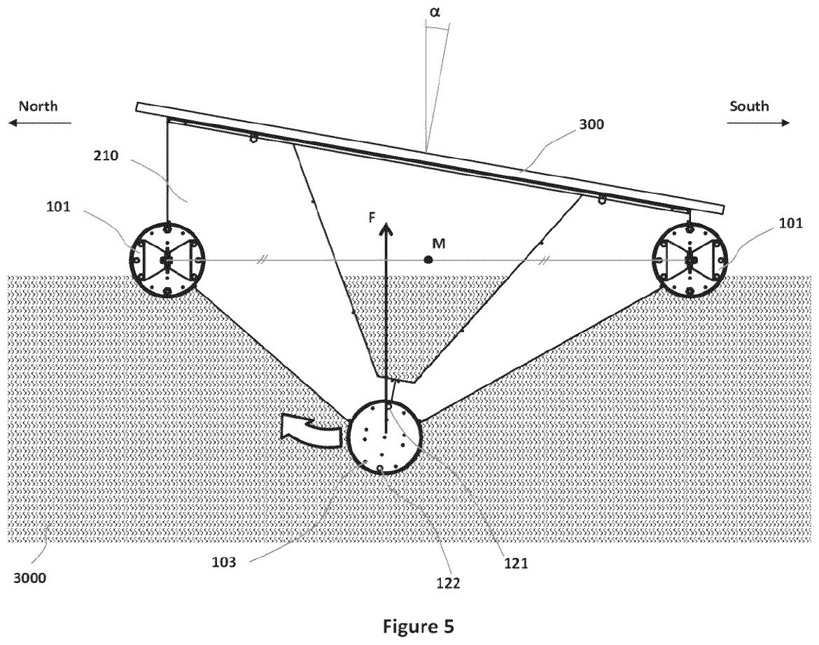

FIG. 5 shows another embodiment of a float assembly of the invention comprising two upper tube elements 101 which are floating above the water body 3000 and a third lower tube element 103 which is entirely immersed in water. For this embodiment of the invention, a control system may be connected to inject air into the lower tube element 103 in order to dynamically adjust the inclination angle (a) of this float assembly.

For this embodiment of the invention, the control system may be equipped with air pumps instead of water pumps in order to fill the tubes of the float assemblies with air and push out water.

In the example illustrated in FIG. 5, the float assembly rotates toward the South direction as the buoyancy of the lower tube element 103 increases when it is partially or fully filled with air. In such embodiment of the invention, short open-ended tubes may be connected to water-line connectors 122 which are located at the bottom of the tube endcaps of the floating tube element. These open-ended tubes enable water to go in and out of the floating tube elements when the control system adjusts the pressure of the air inside the tube internal cavity.

More precisely FIG. 5 shows a lateral view of a float assembly arranged to support an array of photovoltaic solar modules or panels 300. It comprises three hollow floating tube elements, i.e., two upper tube elements 101 (forming the general plan P), and one lower tube element 103. The tube elements 101 and 103 are connected together by N+1 frame assemblies 210 dissymmetric (with regard to the principal axis) form in order to hold the solar modules with an inclined angle α, for instance with a substantially “V” angle shape, the upper tubes being fixed to said branches for example, for one (101) at an intermediate external part of a first branch of the “V” and for the other (101) at the extremity part of the second branch of the “V”. Due to the dissymmetry with regard to the central point M, and when the lower tube is filled with air for instance, the pressure of the force F generates the rotation (arrow on the figure) and therefore the variation of the inclination of the photovoltaic panel 300.

More detailed explanation on the functioning of this embodiment may be found in patent document WO 2020/165272 which is hereby incorporated by reference.

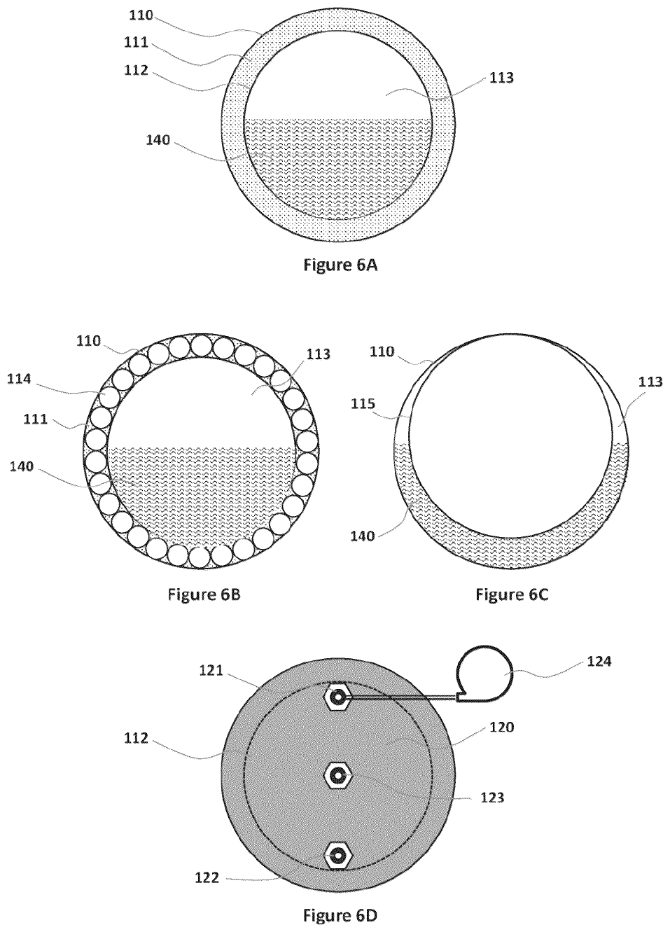

FIGS. 6A, 6B and 6C show cross section view diagrams of elongated cylindrically shaped tube float elements of an embodiment of a solar float assembly of the invention comprising internal cavities which are partially filled with water 140. The remaining volume of the internal cavity 113 not filled by water is filled by air. In one embodiment of the invention, each tube float element comprises an external surface 110, a ring-shaped core 111 and an internal surface 112. The ring-shaped core 111 may be fabricated using a lightweight material such as expanded polystyrene or polyurethane foam.

In another embodiment of the invention, air filled cylindrical cans or spheres 114 may be used to partially or completely fill the ring-shaped core 111. The outer surface 110 of the ring-shaped core 111 may be reinforced with a scratch resistant layer such as a rubber layer, hard plastic shell or a thin metal sheet. The inner surface 112 of the ring-shaped core 111 may be protected with a water proof layer such as a rubber, a plastic film or a thin metal sheet.

FIG. 6C is a cross section of another embodiment of a floating cylindrical tube element with an external surface 110 having an internal cavity 113 containing a plurality of containers 115, for instance airbags floating on internal water 140 present in the interior of said tube element, each of said airbag having a cross section for example of a dimension comprised between ½ and 9/10 of the cross section of the tube element. More precisely the floating containers 115 may have a spherical shape, an oblong cylindrical shape or equivalent.

In a preferred embodiment of the invention, twenty to thirty floating containers 115 may be inserted inside a tube element with a length of five meters in order to ensure that a minimum buoyancy will be preserved if some of the floating containers 115 get perforated. The remaining volume of the internal cavity 113 not filled with water 140 is filled with air.

Both ends of each float tube are closed by an endcap 120 which is illustrated on FIG. 6D. Each endcap 120 may comprise one vent hole 121 located in the upper section of the endcaps 120. In some embodiment of the invention, the vent hole may be connected to an air pump 124 or an alternative source of pressurized air in order to adjust the pressure of the air located inside the tube internal cavity 113.

Additional holes located in the center section 123 or lower section 122 of the endcaps may be added to let water in and partially fill the tube elements with water. After completion of the water filling process, the holes 122-123 can be closed with a cap in order to retain the volume of water inside the tubes. For installations on water reservoirs which can be temporally emptied, this solution provides a mean for keeping a mass of water inside each tube element in order to ballast the float structures which may then safely rest onto the floor of the reservoir.

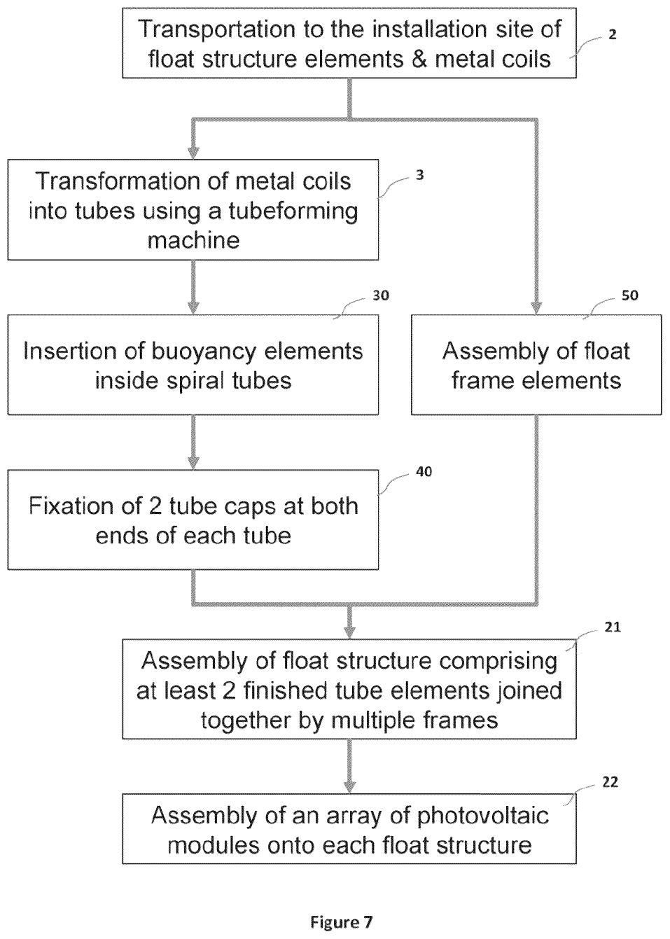

FIG. 7 shows a flow diagram of an exemplary distributed method for fabricating and assembling a floating solar float according to the invention.

In a first step 2, the elements of the float main structure and metal transported onto (or near) the raw coils are installation site of a floating solar plant.

In a second step 3 the raw metal coils are processed and transformed into tubes using a spiral tubeforming machine. In an alternative embodiment of the invention, the raw metal coils may be transformed into tubes using a roll-forming machine.

In a preferred embodiment of the invention, the edges of the metal strip are mechanically joint together using a mechanical crimping process.

In an alternative embodiment of the invention, a thin sheet fastening solution may be used for joining together the side edges of the metal strip.

In a third step 30, buoyancy elements are inserted inside the float tubes.

In a preferred embodiment of the invention, the buoyancy elements comprise bags which are filled with air and then permanently sealed.

In another embodiment of the invention, the buoyancy elements may comprise low density material such as polystyrene or polyurethane foam as described in reference to FIG. 6B.

In a forth step 40, two endcaps are attached to the ends of each float tube. The endcaps may be attached to the float tubes using thin sheet mechanical fastening solutions or other fastening methods know in the art.

Parallelly the float frame elements are assembled (step 50).

In a fifth step 21, a pair of finished tube elements are joined together with a linear array of frame assemblies in order to form the float structure of the invention.

In a preferred embodiment of the invention, the frame elements are assembled together onsite to form frame assemblies in order to reduce the volume required for transporting these elements to the site. The frame elements may be assembled together to form frame assemblies using thin sheet mechanical fastening solutions.

In a final step 22, an array of photovoltaic modules are mounted onto each float assembly before launching this element into water.

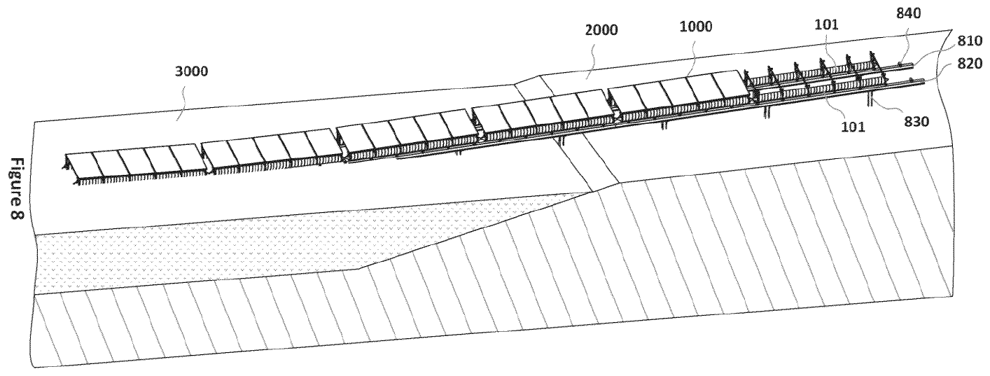

In a preferred embodiment of the invention, the solar floats equipped with photovoltaic modules are launched into water using a launch ramp as illustrated in FIG. 8.

The launch ramp may comprise a pair of two rail elements 810 & 820 which may be equipped with rollers 840 having a saw-horse shape with a curvature complementary to the shape of the external surface of the floating tube elements 101, in order to support and guide the main tube elements of the solar floats 1000.

In a preferred embodiment of the invention, the launch ramp is configured to have a total length which is relatively long in order to support multiple float elements. The rail elements 810 & 820 are supported by an array of vertical posts 830. These vertical posts may have adjustable lengths foots or simply driven into the ground using a post ramming machine or mounted onto other foundation elements such as concrete blocks or ground screws depending of the type and quality of the soil of the shore nearby the water body.

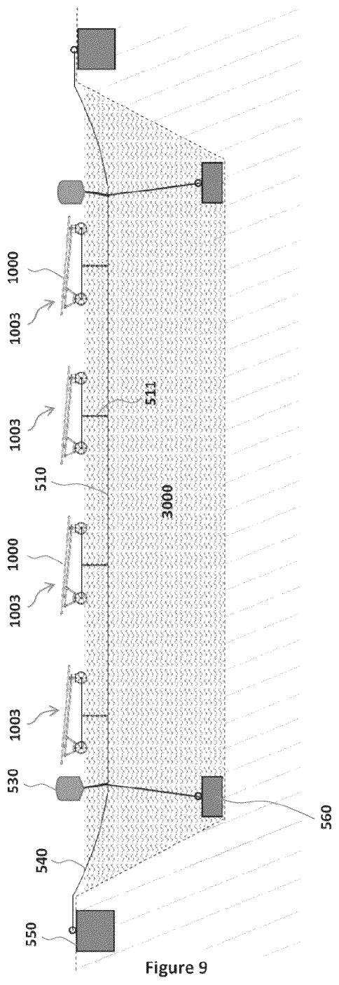

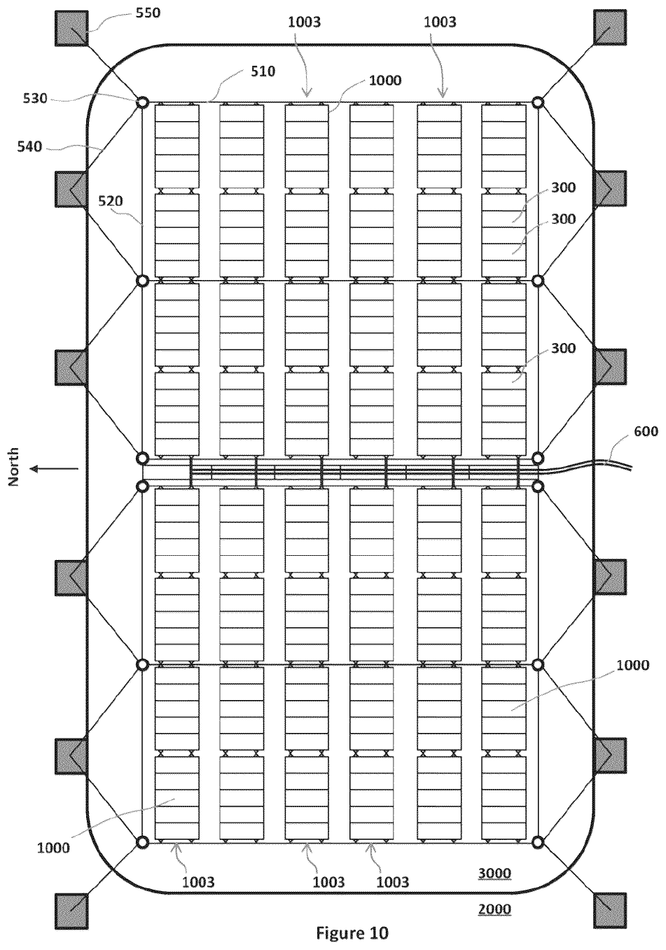

FIGS. 9 and 10 show respectively a side view diagram and a top view diagram of exemplary embodiments of different solutions for anchoring an array of solar float assemblies 1000 according to the invention in a water body.

FIG. 9 shows in side view four arrays 1003 of float assemblies 1000.

In this preferred embodiment of the invention, the float assemblies 1000 are mechanically connected to a linear array of horizontal cables 510. In an advantageous embodiment of the invention, the horizontal cables 510 are positioned at a depth of at least 0.5 m under the water surface in order to provide clear service paths between the rows of float assemblies. Short vertical cables or chains 511 are used for mechanically connecting the float assemblies 1000 to the horizontal cables 510.

FIG. 10 shows a floating photovoltaic solar system on a water body 3000 comprising two sets of six arrays 1003, each forming a row of four float assemblies 1000 in series, each float assembly comprising five photovoltaic panels 300 connected in series to main electric cable for collecting electricity from the panels and providing it to a solar inverter (not represented) for instance on shore in a manner known per se.

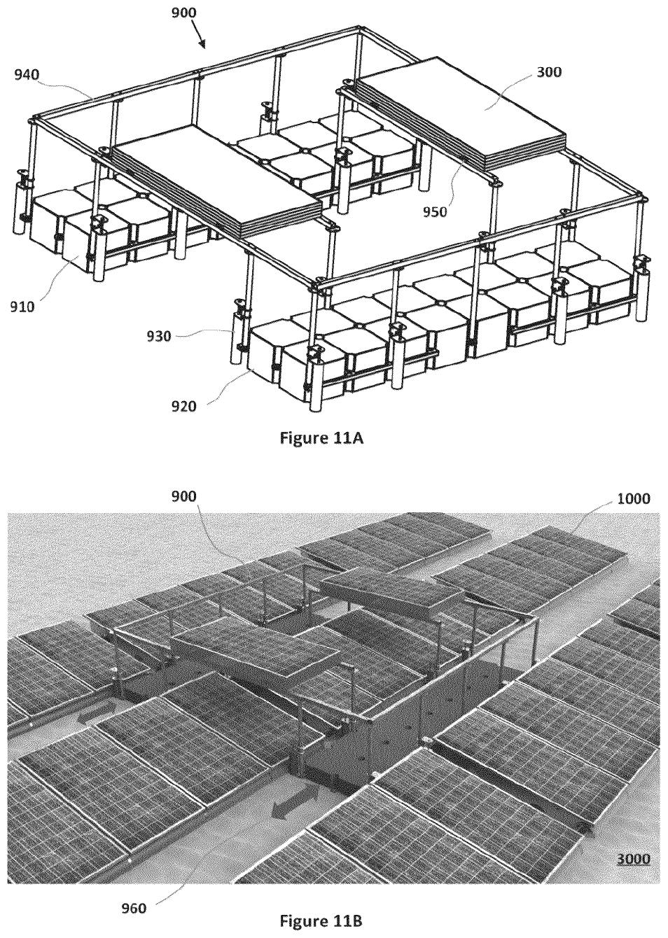

In such configuration, maintenance operations such as replacement of defective solar modules can easily be performed using a by a maintenance team narrow service boat or preferably using a dedicated maintenance platform as described hereafter in reference to FIGS. 11A and 11B.

In order to reduce the number of horizontal cables required (see FIG. 10), one or multiple float assemblies may be mechanically connected together in a series manner along the North-South direction and only their upper and lower ends are then mechanically connected to the horizontal cables 510. The East and West side of each horizontal cable 510 are mechanically connected to vertical cables 520.

A pair of horizontal 510 and vertical cables 520 forms a block of tracker float assemblies 1000 which are secured with anchoring cables 540 attached to one of multiple fixed foundation points which are installed on shore (example concrete pile 550) or at the bottom of the water body (example 560).

Ground anchors driven into the soil or solid ballast blocks may be used as fixed foundation points. Buoys 530 may be added at the end of the horizontal cables 510 in order to compensate vertical forces induced by the anchoring cables 540 connecting the horizontal 510 and vertical 520 cables to the foundations 550.

The anchoring cables 540 may be equipped with tensioner devices in order to accommodate water height variations.

FIGS. 11A and 11B respectively show a 3D view diagram and a rendered illustration of a specific platform 900 for performing maintenance operations on the floating solar system according to the invention.

In a preferred embodiment of the invention, the maintenance platform 900 comprises a pair of buoyancy elements 910 & 920 which are joined together by a frame structure 940 in order to create a stable catamaran type platform which can navigates through a floating solar plant of the invention by employing the water access lanes 960 between the rows of float assemblies 1000.

In this configuration, two maintenance persons can positioned on each side of the maintenance platform to easily lift and replace a defective solar panel from a solar float assembly 1000. In a preferred embodiment of the invention, the maintenance platform 900 is equipped with two parallel racks 950 at a determined distance from each other which is arranged to be slightly less than the width of the panels, to support such panels to be removed and/or repaired, and for storing accordingly new and defective solar panels 300.

The buoyancy elements 910 & 920 are preferably equipped with side rollers 930 in order to guide the maintenance platform 900 along the tubes of the solar float assemblies 1000.

As opposed to prior art floating solar systems which comprise densely packed blocks of interconnected plastic floats, the herein disclosed maintenance platform uniquely enables maintenance operations to be performed in a safer manner. The solar float assemblies according to the invention are organized in independent rows according to a specific layout as illustrated in FIG. 10.

Using the herein disclosed specific maintenance platform, the maintenance persons do not need to walk across a floating solar plant on relatively narrow and unstable floating access lanes to replace defective solar panels. The herein disclosed maintenance platform can also be used for cleaning the solar panels.

In a preferred embodiment of the invention, this maintenance platform may be equipped with rotating brushes and/or water jets in order to clean the top surface of the solar panels in a semi-automated manner.

In the specific case of floating solar installations requiring frequent cleaning operations (exposed to a dusty environment or to frequent bird drops), the displacements of the maintenance platform may be controlled in a fully automated manner by an electronic control system.

In another embodiment of the invention, the solar floats according to the invention may be equipped with a specific water drip system (not shown).

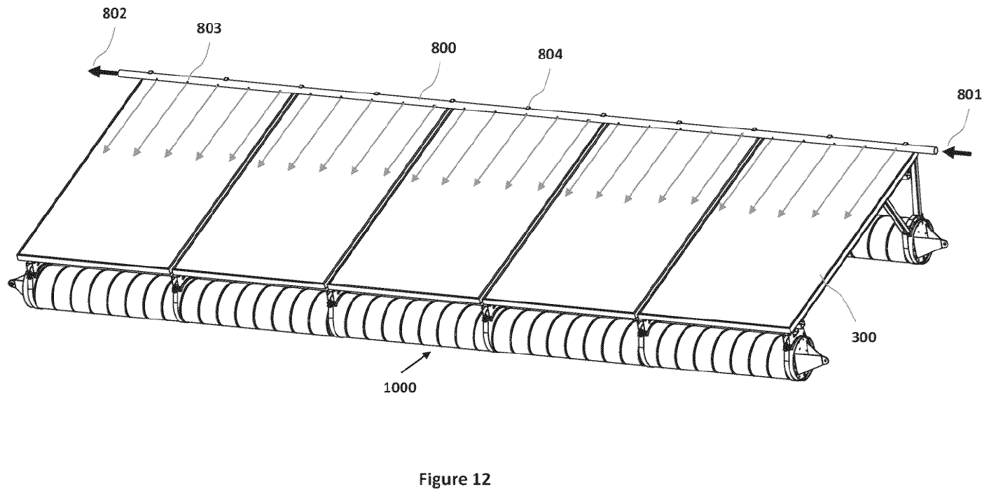

FIG. 12 presents an exemplary embodiment of a water drip system comprising a perforated water pipe 800 which is attached along the upper side of the solar panels 300 using an array of fixation clips 804.

An external water pump (not illustrated) is used for pumping fresh water from the water body or the reservoir onto which the floating solar system is installed.

Multiple float assemblies may be connected in a series manner by connecting the output inlet 802 of the perforated water pipe to the input inlet 801 of the following float assembly 1000. The number and opening diameter of the water pipe perforations 803 should be optimized depending on the flowrate of the selected water pumps and the number of float assemblies 1000 connected in series.

This water drip solution provides a mean for cleaning the upper surface of the solar panels 300 in a fully automated manner.

As the temperature of water pumped at a depth greater then ˜1 m is always positive, this water drip system also provides a solution for preventing the accumulation of snow on the surface of the solar panels.

In the specific case of floating solar systems installed on sites which are exposed to heavy snow falls, the herein disclosed water drip solution provides a mean for continuously melting the snowflakes when they are falling onto the surface of the solar panels using the calories stored in the deep water of the reservoir.

An electronic control system may be added in order to stop or adjust the flowrate of the water pumps in an optimized manner depending on the external environmental conditions (sun irradiance, water temperature, air temperature, wind-speed . . . ).

In the specific case of sites subject to very cold temperatures, the water pumps should always be started before the external air temperature drops below 0° ° C. in order to ensure that the water inside the water pipes does not freeze. For these extremely cold sites, all the water pipes of the water drip system should preferably be thermally insulated in order to maximize the system overall efficiency and eliminate the risk of water freezing inside the water pipes.

With the possibility of easy maintenance and cleaning of the photovoltaic panels, it is possible to install large islands of float assemblies covering great superficies (more than 1000 square meters), typically for instance an array of more than 100 individual assemblies of five photovoltaic panels for instance connected together.

The invention has been described with reference to various specific and preferred embodiments and methods. However, it should be understood that variations and modifications may be made while remaining within the spirit and the scope of the invention.

This invention is not to be limited by the embodiments disclosed, including any shown in the drawings or exemplified in the specifications, which are given by way of example or illustration and not of limitation.

The scope of the invention shall only be limited by the claims.

1. A method for realization of a floating photovoltaic solar system on a water site, said water site having a shore and a water body, said system comprising photovoltaic panels each having a mechanical structure and at least one array of float assemblies, each array of float assemblies comprising at least one float assembly, each float assembly comprising at least one group of at least two floating tube elements for supporting said photovoltaic panels, wherein it comprises the following steps:
obtaining and transporting on the water site coils of thin material,
processing on shore and in situ at least two elongated ribbons or at least two extended sheets obtained from said coils for deforming said ribbons or bending said sheets into at least two corresponding thin wall elongated hollow open tube elements, said open tubes elements extending along a respective primary axis and having respectively unjointed elongated edges arranged to lie against each other, said processing including the step of using a spiral tube forming machine in case of ribbons or a roll-forming machine in case of sheets,
mechanically joining together, the elongated edges of said ribbons or of said sheets using a mechanical crimping, fastening or fixing process, for forming said respective floating tube elements,
fixing an endcap to each end of each of said floating tube elements,
joining together said floating tube elements of each of said group of floating tube elements, with frame assemblies, and mounting said photovoltaic panels onto said frame assemblies or joining together said floating tube elements of each group by fixing the mechanical structure itself of the photovoltaic panels on said floating tube elements, in order to form said at least one array of float assemblies and forming accordingly said floating photovoltaic system,
and launching said floating photovoltaic system into water.

2. The method according to claim 1, characterized in that said processing is using a spiral tube forming machine to deform said ribbons in spiral having their unjointed longitudinal adjacent elongated edges mechanically crimped together to fabricate said respective floating tube elements, and/or characterized in that said processing is using a roll forming machine to bend said sheets in order to have their unjointed elongated edges relying against each other and then having them mechanically joined together using such mechanical crimping, fastening or fixing process for forming said respective floating tube elements.

3. (canceled)

4. The method according to claim 1, characterized in that the coils are raw metal coils, and/or characterized in that it further includes the step of inserting buoyancy elements inside said floating tubes elements, before fixing the end-caps.

5. (canceled)

6. The method according to claim 4, characterized in that the end-caps having a centered or substantially centered aperture authorizing overflow, the method comprises, after launching, the step of having water leaking into the bottom of the floating tube elements up to the overflow aperture while said floating tube elements are immerged so as to augment the stability of the system.

7. The method according to claim 1, characterized in that the launching of the system comprises a step of placing two guiding elongated rails elements with one extremity on shore and the other extremity sufficiently immerged into the water body, a step of mechanically connecting together in series and in line at least two float assemblies to form a corresponding array of float assemblies, said array therefore forming a train of connected float assemblies while placing such array on said two parallel guiding elongated rails elements such as to form a launch ramp in order to support and guide said train of solar floats assemblies into the water body, the floating tube elements being arranged to slide along the rails and a step of driving such train entirely into the water body by pushing and/or pulling such train accordingly.

8. The method according to claim 7, characterized in that providing said launch ramp with a total length superior to ten meters in order to support a plurality of at least two arrays of float assemblies, each array comprising at least five photovoltaic solar panels.

9. The method according to claim 8, characterized in that the placing of the guiding elongated rails elements comprises providing an array of vertical posts having adjustable lengths foots driven into the ground using a post ramming machine or mounted onto other foundation elements such as concrete blocks or ground screws, to support such rails elements.

10. The method according to claim 1, characterized in that the method further comprises a step of dispatching a plurality of arrays of float assemblies on a predetermined surface of the water body, a step of providing a linear array of a plurality of horizontal cables positioned at a depth of at least 0.5 m under the water surface, and a step of using short vertical cables or chains for mechanically connecting said arrays of float assemblies to the horizontal cables, and a step of providing anchoring lines connecting said horizontal cables to an array of anchoring points installed on shore and/or at the bottom of the water body.

11. The method according to claim 10, characterized in that the method further comprises the step of arranging around at least one array of float assemblies or a group of arrays of float assemblies, one pair of corresponding external (or peripheral) lateral horizontal cables and one pair of corresponding external longitudinal horizontal cables perpendicular to said pair of lateral horizontal cables and belonging to said array of a plurality of horizontal cables and securing such array or group of arrays with anchoring cables attached to a plurality of fixed foundation points.

12. The method according to claim 1, characterized in that the solar float system being organized in parallel rows of at least two arrays of float assemblies, therefore creating external or intermediate parallel free water surface or canal having a width equal or superior to a predetermined value, the method of installation further comprises a maintenance method comprising the step of performing maintenance operations on said floating solar system by using a maintenance platform comprising a pair of buoyancy elements which are joined together by a superior frame structure in order to create a stable catamaran type platform floating on said two parallel canals along and/or between two adjacent rows of arrays of float assemblies and navigating above and between said rows of float assemblies to maintain and/or replace defective solar modules.

13. A floating photovoltaic solar system on a water site having a shore and a water body, said system comprising photovoltaic panels and at least one array of float assemblies, each array of float assemblies comprising at least one float assembly,
wherein each float assembly comprises at least one group of at least two floating tube elements for supporting said photovoltaic panels,
each of said floating tube elements having a thin (i.e. <1 mm) elongated wall extending along a primary axis, said floating tube elements being formed by bending metal ribbons or sheets extracted from raw metal coils using a spiral tube forming machine or a roll-forming machine, to obtain an open cylinder with adjacent longitudinal edges facing each other, and having means of fixation by mechanical crimping, fastening, gluing or welding of such adjacent longitudinal edges of such open cylinder to close longitudinally such floating tube elements,
each end of said floating tube elements being closed by an endcap,
wherein it comprises frame assemblies to support said photovoltaic panels in order to form said at least one array of float assemblies for forming said floating photovoltaic system,
and a launching apparatus of said at least one array of float assembly forming said floating photovoltaic system into the water body.

14. A floating photovoltaic solar system according to claim 13, characterized in that each float assembly comprises at least one group of three parallel floating tube elements for supporting said photovoltaic panels, and/or characterized in that the floating tube element not being waterproof, the end-caps have a substantially centered aperture authorizing overflow of water when said floating tube element is immerged, and/or characterized in that each floating tube element comprises at least one buoyancy element inside.

15-16. (canceled)

17. A floating photovoltaic solar system according to claim 13, characterized in that the system comprises multiple mooring lines operably connected to said array of float assemblies.

18. A floating photovoltaic solar system according to claim 17, characterized in that the system comprises anchoring lines connecting said mooring lines to an array of anchoring points.

19. A floating photovoltaic solar system according to claim 13, characterized in that each float assembly comprises a minimum of three frame elements extending along a direction which is perpendicular to said primary axis of said floating tube elements, and/or characterized in that the system comprises a plurality of arrays of float assemblies, forming a train of connected float assemblies and the launching device comprises two parallel guiding elongated rails elements arranged to support and guide said train of solar floats assemblies into the water body.

20. (canceled)

21. A floating photovoltaic solar system according to claim 13, characterized in that the system comprises a plurality of horizontal cables and a short vertical cables or chains mechanically connected to said arrays of float assemblies and anchoring lines connecting said horizontal cables to an array of anchoring points installed on shore and/or at the bottom of the water body.

22. A floating photovoltaic solar system according to claim 21, characterized in that the system further comprises for at least one array of float assemblies or a group of arrays of float assemblies, one pair of corresponding external (or peripheral) lateral horizontal cables and one pair of corresponding external longitudinal horizontal cables perpendicular to said pair of lateral horizontal cables and belonging to said array of a plurality of horizontal cables and securing such array or group of arrays with anchoring cables attached to a plurality of fixed foundation points.

23. A floating photovoltaic solar system according to claim 13, characterized in that the floating photovoltaic solar system comprises a maintenance platform comprising a pair of buoyancy elements which are joined together by a frame structure to form a catamaran type platform.

24. A floating photovoltaic solar system according to claim 13, characterized in that it comprises a water drip system, said water drip system comprising at least one perforated water pipe attached along the upper side of the solar panels using an array of fixation clips and an external water pump for pumping fresh water from the reservoir onto the upper surface of said solar panel.

25. A floating photovoltaic solar system according to claim 24, characterized in that the water drip system comprises multiple perforated water pipes connected in a series manner by connecting the output inlet of a first perforated water pipe to the input inlet of the following float assembly.
